(19) United States
(12) Patent Application Publication
(10) Pub. No.: US 2026/0072947 A1
(43) Pub. Date: Mar. 12, 2026

(54) AUTOMATED DETERMINING OF METADATA TAGS

(71) Applicant: HEWLETT PACKARD ENTERPRISE DEVELOPMENT LP, Spring, TX (US)

(72) Inventors: Ajay Yadav, Bangalore (IN); Samuel John, Bangalore (IN); Chirag Talreja, Bangalore (IN); Rashmi Narayan, Bangalore (IN); Jayasankar Nallasamy, Bangalore (IN); Ranjani Nagarajan, Bangalore (IN); Pruthvi Raju, Bangalore (IN)

(21) Appl. No.: 18/937,496

(22) Filed: Nov. 5, 2024

(30) Foreign Application Priority Data
Sep. 12, 2024 (IN) 202441069057

(51) Int. Cl. G06F 16/28

(52) U.S. Cl. CPC G06F 16/285

(57) ABSTRACT

Systems and methods are provided for automated metadata tag score determination that leverages machine learning (ML) models and weighted knowledge graphs to obtain and assign metadata tag scores to instances of underlying data. Examples include generating a domain-specific knowledge graph related to a particular domain. The domain-specific knowledge graph comprising a plurality of domain-specific features connected via a plurality of domain-specific relationships. Responsive to receiving an input tag, examples extract domain-specific features of the plurality of domain-specific features associated with the input tag and a subset of domain-specific relationships of the plurality of domain-specific relationships corresponding to the subset of domain-specific features. The examples then determine metadata tag score corresponding to the input tag for items of the particular domain based on the subset of domain-specific features and the subset of domain-specific relationships and update metadata for each item to include the determined metadata tag scores.

### BACKGROUND

Cluster analysis or clustering is the task of grouping a set of objects in such a way that objects in the same group (referred to as a cluster) are more similar to each other than to those in other clusters. Clustering can be a main task of exploratory data analysis, and a common technique for statistical data analysis, used in many fields, including pattern recognition, image analysis, information retrieval, bioinformatics, data compression, computer graphics and machine learning. Metadata, which is data that provides information about other data, can be leveraged to categorize and organize the objects into clusters.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 is a block diagram of an example environment for automated metadata tag scoring, in accordance with implementations of the present disclosure.

FIGS. 2A and 2B depict example metadata data structures, in accordance with an example implementation of the present disclosure.

FIGS. 3A and 3B depict an example domain-specific knowledge graph, in accordance with implementations of the present disclosure.

FIG. 4 depicts another example domain-specific knowledge graph, in accordance with an example implementation of the present disclosure.

FIG. 5A illustrates example metadata data structure comprising metadata tag scores, in accordance an example implementation of the present disclosure.

FIG. 5B illustrates example metadata data structure clustered according to metadata tag scores, in accordance an example implementation of the present disclosure.

FIG. 6 illustrates an example process for performing automated metadata tag score determination, in accordance with examples disclosed herein.

FIG. 7 is an example computing component that may be used to implement various features for performing automated metadata tag score determinations in accordance with the implementations disclosed herein.

FIG. 8 illustrates another example computing component that may be used to implement automated determining of metadata tags in accordance with the implementations disclosed herein.

FIG. 9 is a computing component that may be used to implement examples of the disclosed technology.

The figures are not exhaustive and do not limit the present disclosure to the precise form disclosed.

### DETAILED DESCRIPTION

Examples of the presently disclosed technology provide an automated determining of metadata tags through an automated metadata tag score determination platform that leverages machine learning (ML) models and weighted knowledge graphs to automatically obtain and assign metadata tag scores to instances of underlying data. The metadata tag scores can provide information on various attributes provided, for example, as metadata descriptive of the instances of the underlying data. In examples, the metadata may be descriptive of instances (e.g., items, objects, products, etc.) of a particular domain. Metadata tag scores determined in accordance with the present disclosure can have a wide range of applications including, but not limited to, content organization, improved data retrieval in terms of speed and/or accuracy, classification of instances of underlying data into categories, generating recommendations based on the distribution of the instances of the underlying data across various attributes, etc. As an example, the instances of underlying data can be clustered in accordance with the metadata tag scores to provide for classification and other applications.

Conventional approaches do not provide an automated mechanism for obtaining metadata tag scores and assigning them to instances of the underlying data. Traditionally, computing metadata tag scores used a manual rule-based approach, in which a subject-matter expert would manually define a computation rule using their subject-matter expertise. For example, the subject-matter expert manually identifies features of a given tag and defines the computation rule by manually determining weights to apply to each identified feature. The weights are typically determined through a subjective approach, whereby the subject-matter expert decides weights use best judgment in view of the subject-matter knowledge. A score for each instance of the underlying data can be computed from the computation rule and each instances tagged with metadata based on the computed scores. In addition to having to manually identify features and computation rules, for any new features or instances of underlying data the conventional approach may necessitate manually updating and redeploying the computation rules to obtain new tags. Given the anticipated increase in data, tags, and features over time, this approach can be time-consuming, labor-intensive, and often suffers from inflexibility and limited scalability.

Examples herein provide an automated process for determining metadata tag scores for metadata data descriptive of instances of a particular domain. The metadata can be updated to include the metadata tag score, which can be used, in some examples, to cluster the instance for classification and organization. The examples herein input domain-specific data (e.g., data descriptive of a particular domain in general) into a ML model. The ML model ingests the domain-specific data and generates a knowledge graph for that particular domain (referred to as a domain-specific knowledge graph). This knowledge graph can contain a plurality of nodes and connectors that connect the nodes based on domain-specific features and relationships therebetween discovered by the ML model. For example, each node may represent a given domain-specific feature discovered by the ML model from the domain-specific data with connectors representing domain-specific relationships (also referred to as interdependence or dependence) between the nodes. Connectors can define a relative importance of each domain-specific feature on another domain-specific feature.

Examples herein can extract a subset of domain-specific features from the knowledge graph based on (e.g., responsive to) receiving an input tag. The input tag may be included in a query specifying the input tag. The input tag may correspond to a node of the domain-specific knowledge graph (referred to herein as an input node) and the examples herein may extract those domain-specific features (e.g., other nodes) connected to the input node. Domain-specific relationships between the domain-specific features and the input node can also be extracted and associated with each extracted domain-specific feature.

In various examples, metadata tag scores can be determined based on the extracted domain-specific features and associated domain-specific relationships. For example, the disclosed technology can generate a metadata score algorithm from the extracted domain-specific features and associated domain-specific relationships, which can be executed to compute a metadata tag score for each instance of the domain under consideration. In various examples, each extracted domain-specific feature may represent a variable parameter and weights for each variable parameter may be derived from the associated domain-specific relationships. In these examples, the metadata score algorithm may be provided as a summation of the variable parameters and corresponding weights. To compute a metadata tag score, a value of each extracted domain-specific feature can be obtained from metadata descriptive of a particular instance of the underlying data and used to populate the corresponding variable parameters. The metadata score algorithm can be executed for each of the instances of the underlying data to obtain metadata tag scores for each instance. The instances can then be tagged with the respective metadata tag score, for example, by updating the metadata to include the metadata tag scores, which can be used to cluster and organize the instance according to their respective scores.

In various examples, one or more LLMs may be used to generate domain-specific knowledge graphs. Examples herein may utilize any LLMs, such as but not limited to, OpenAI's GPT series of models (e.g., GPT-4 and the like), Gemini developed by Google, LLAMA models developed by Meta, and the like. In these examples, domain-specific data containing descriptive information about items of a particular domain can be applied to the one or more LLM tools, which can parse the domain-specific data to identify domain-specific features of the domain-specific data and domain-specific relationships between these domain-specific features. The one or more LLMs can assign weights to each domain-specific relationship based parsing the domain-specific data. Using the identified domain-specific features as nodes and domain-specific relationships as connection, the one or more LLMs can generate a domain-specific knowledge graph for that particular domain and assigns respective weights to the connections.

In domains with extensive information, such as compute nodes and computation resources, where thousands of interconnected entities can exist, domain-specific knowledge graphs can offer a method for representing and retrieving information that is superior to relational databases. For example, knowledge graphs can be flexible and schema agnostic. As a result, they are well suited for integrating new data and relations. Additionally, knowledge graphs can provide improved storage of highly interconnected data points, because such avoids multiple JOIN operations of relational database management systems (RDBMS).

Furthermore, utilizing LLMs to construct domain-specific knowledge graphs, opposed to generating responses, provides improved efficiency in identification and retrieval of connected nodes directly from the domain-specific knowledge graph compared to using LLMs for response generation. For example, the disclosed technology can utilize connectors in a domain-specific knowledge graph to identify connected nodes, which can be retrieved along with corresponding weights. Whereas, response generation LLM tools, such as Retrieval Augmented Generation (RAG), utilize vectorized embeddings of document chunks. These document chunks are compared against vectorized embedding of a user query to generate meaningful responses, which can be less efficient. For example, the domain-specific knowledge graphs of the disclosed technology can provide look up entities and associated features as keywords, opposed to documents. Thus, vectorized embedding comparisons, which often involve computationally expensive similarity measures, may not be required in the examples disclosed herein that leverage domain-specific knowledge graphs. Whereas, the examples herein utilize domain-specific metadata that serves as the knowledge base and a knowledge graph index can be more suitable because connected nodes can be obtained via graph traversal.

Furthermore, the domain-specific knowledge graphs can be easily visualized, verified, and modified as needed. For example, existing visualization and editing tools can be used to provide an easy way for subject matter experts to visualize, edit and tune knowledge graphs if required.

In an illustrative example, domain-specific data may be data descriptive of computation resources of an interconnected network. The computation resources may be, for example, but not limited to, software process (e.g., a client or a server), a virtual machine, a virtual controller of a storage software stack, a storage server, a data virtualization platform, and the like that can be dedicated to completing computation tasks. In this example, metadata tag scores can provide quantifiable measures of dependence of metadata to set of domain-specific features for the computation resources. For example, metadata tags could include, but are not limited to, performance of respective computation resources, risk to respective computation resources, and cost of operating respective computation resources, to name a few. Each metadata tag may be associated with a set of domain-specific features, such as environmental risk (e.g., flood earthquake), cyber risk, and compliance risk to name a few in the case of an example risk tag. Thus, examples of the technology disclosed herein can provide an automated process for determining scores for each metadata tag for each computation resource. The computation resources can then be clustered for classification and organization that ultimately can provide for optimal configuration of the computation resources.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

The following detailed description refers to the accompanying drawings. Wherever possible, the same reference numbers are used in the drawings and the following description to refer to the same or similar parts. It is to be expressly understood that the drawings are for the purpose of illustration and description only. While several examples are described in this document, modifications, adaptations, and other Implementations are possible. Accordingly, the following detailed description does not limit disclosed examples. Instead, the proper scope of the disclosed examples may be defined by the appended claims.

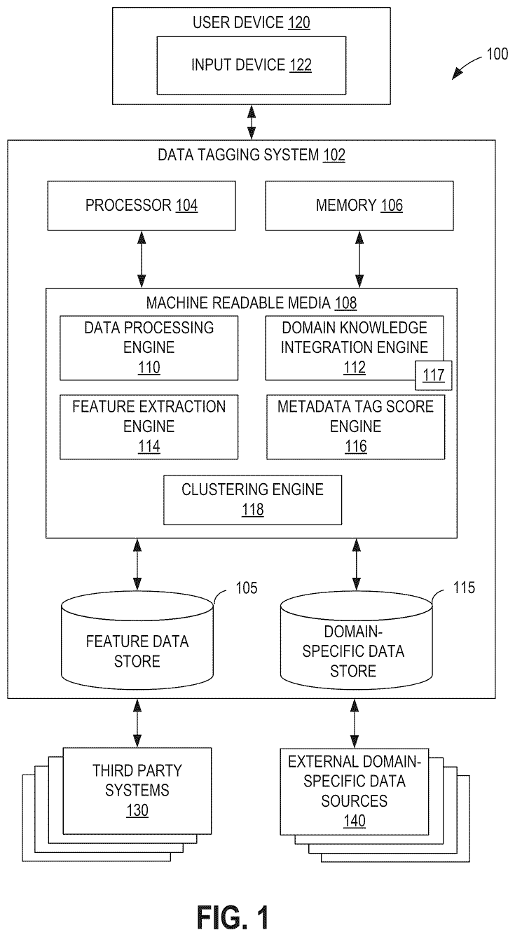

FIG. 1 is a block diagram of an example environment 100 in accordance with implementations of the present disclosure. In the example of FIG. 1, environment 100 comprises a data tagging system 102 that is communicable coupled (e.g., via wired or wireless communication connection) to a client device 120, third party system(s) 130 and domain-specific data source(s) 140. Data tagging system 102 may be a server computer that communicates via network communications to other devices accessible on the network, including client device 120, third party system(s) 130, and domain-specific data source(s) 140.

In the example of FIG. 1, third party system(s) 130 may include a high-performance computing (HPC) systems configured to aggregate computing power to deliver appreciably higher performance than can be achieved by a single typical computing device. Third party system(s) 130, in this example, may comprise a plurality of compute nodes, each of which may comprise computation resource that can be utilized during running workloads of the third party system(s) 130. As used herein, a “compute node” generally refers to a computing element. The compute nodes may be computer systems (e.g., clients, servers, or peers) in virtual or physical form, one or more components of a computer system, computing elements, compute engines, hardware devices, software entities or processes, or a combination thereof. Non-limiting examples of compute nodes include a software process (e.g., a client or a server), a virtual machine, a virtual controller of a storage software stack, a storage server, a data virtualization platform, a sensor, or an actuator. As used herein, a “computation resource” generally refers to hardware or software that an executed and/or utilized for performing workload tasks by a compute node. The computation resources can refer to resources utilized in computing results (e.g., GPUs, CPUs, and the like), as well as resources utilized for data storage (e.g., Random Access Memory (RAM), non-volatile RAM (NVRAM), an Electrically Erasable Programmable Read-Only Memory (EEPROM), and other machine-readable storage mediums).

In various examples, the third party system(s) 130 may generate raw metadata that is descriptive of the instances of the third party system(s) 130. In the example of FIG. 1, third party systems 130 may generate raw metadata descriptive of the compute nodes of the third party systems 130. For example, third party system(s) 130 may generate metadata including unique identifiers for each compute node and attributes of the compute nodes. The attributes may include, but are not limited to, unique identifiers, host names, operating system type (osType); physical site (e.g., in terms of a descriptive geographic location, geo-coordinates, or the like); computation resources, including quantitative and qualitative descriptive data; costs of operation per-gigabyte of data, which may be provided in terms of energy costs, monetary costs, temporal costs, etc.; physical site operation costs (e.g., costs for operating the physical location in which the compute node, or hardware virtualizing the compute node, is located), in terms of in terms of energy costs, monetary costs, temporal costs, etc.; input/output operations per second (IOPS); throughput; latency; number of CPU (or GPU) cores; clock speeds of CPUs/GPUs; environmental risks to the compute node (e.g., floors, earthquakes, or other natural disasters that may impact operation of the compute node); cyber risks to the compute node (e.g., malicious attacks thereto); and compliance risks of the compute node (e.g., compliance with governing bodies), to name a few examples. While certain examples are provided herein, the disclosed examples are not intended to be limited to the specific examples. It is to be understood that the examples herein are for the illustrative purpose only, and other attributes and characteristics may be included according to a desired application. In some examples, third party system(s) 130 may generate audit files, log files, and the like that contain the raw metadata. In some examples, third party system(s) 130 may include, but not limited to, test systems, development systems, or production systems where product related applications are hosted.

Domain-specific data source(s) 140 may be configured to generate domain-specific data for a particular domain. The domain-specific data source(s) 140 may be any data source that can generate data specific to this domain. In examples, domain-specific data source(s) 140 may generate a corpus of data specific to the particular domain. Domain-specific data source(s) 140 may include websites on the Internet, journal articles, blogs, product documents, user guides, advisories, any multimedia source that is related to (e.g., descriptive) to a particular domain. Domain-specific data source(s) 140 may include data sources that are external to system 102, as well as data sources that are internal to system 102. For example, Wikipedia webpages of a particular domain may be one example domain-specific data source. In an example, the particular domain may be compute nodes and/or related computation resources, and https://en.wikipedia.org/wiki/Virtual_machine may be just one example domain-specific data source for a Virtual Machines within the compute node domain. In another example, medical journal websites or articles may be an example source of a medical field domain. While the domain-specific data may overlap with the raw metadata, the domain-specific data need not include the raw metadata and may refer to data that provides general information, context, and semantics about the domain of compute nodes and/or computation resources, opposed to information about the specific compute nodes of third party systems 130. In some examples, domain-specific data source(s) 140 may comprise websites, servers, and other data sources that are communicably accessible over the Internet, as well as accessible through direct communication over a network.

Processor 104 may comprise a general-purpose or special-purpose processing engine such as, for example, a microprocessor, controller, or other control logic. Processor 104 may be connected to a bus, although any communication medium can be used to facilitate interaction with other components of data tagging system 102 or to communicate externally.

Memory 106 may comprise random-access memory (RAM) or other dynamic memory for storing information and instructions to be executed by processor 104. Memory 106 might also be used for storing temporary variables or other intermediate information during execution of instructions to be executed by processor 104. Memory 106 may also comprise a read only memory (“ROM”) or other static storage device coupled to a bus for storing static information and instructions for processor 104.

Machine readable media 108 may comprise one or more interfaces, circuits, and modules for implementing the functionality discussed herein. Machine readable media 108 may carry one or more sequences of one or more instructions that can be executed by processor 104. Such instructions embodied on machine readable media 108 may enable data tagging system 102 to perform features or functions of the disclosed technology as discussed herein. For example, the interfaces, circuits, and modules of machine readable media 108 may comprise, for example, data processing engine 110, Domain knowledge integration engine 112, feature extraction engine 114, metadata tag score engine 116, and clustering engine 118.

Data processing engine 110 may be configured to obtain raw metadata from third party systems 130. The format of the metadata may comprise a structured format, such as JSON, XML, or binary. In some examples, the data is ingested by collecting, receiving, and storing the raw metadata generated by the third party systems 130 in data store 105. In some examples, data processing engine 110 may obtain the raw metadata directly from third party systems 130 by querying an API of the third party systems 130. Data processing engine 110 can receive a response to the query containing raw metadata. In another example, alone or in combination with the API query, data processing engine 110 may obtain raw metadata indirectly from third party systems 130, for example, by mining through log files, audit files, or the like. As an example, data processing engine 110 may query a calamity data source, as an example third party systems 130, using geo-coordinates to obtain an environmental risk for a specific site at the queried geo-coordinates.

Data processing engine 110 may be configured to prepare the raw metadata for usage during a data processing pipeline to facilitate data processing. For example, data processing engine 110 may be configured to perform one or more of the following processing operations on the raw metadata received from third party systems 130: clean the raw metadata received from third party systems 130; normalize the raw metadata; perform feature scaling on the raw metadata, and manage missing values. A cleaning operation may involve removing noise and irrelevant information from the raw metadata. A normalization and feature scaling operations are two ways of converting multiple data fields into a common range. Depending on eh kind of data, one or both techniques may be applied. Dealing with missing values may entail executing imputation or deletion strategies to add a missing value as an average value (or other means of estimating a missing value) or delete an instance of missing values. Additionally, in some examples, data processing engine 110 may be configured to perform an encoding operation that encodes categorical variables into a numerical format (e.g., encoding “red”, “green”, and “blue” to 0, 1, and 2; “high”, “medium”, and “low” to 0, 1, and 2; etc.).

In examples, data processing engine 110 can generate a processed feature list from the processed metadata. The processed feature list may be a data structure comprising a listing of features of each compute node of third party systems 130 identified from the raw metadata associated with the attributes specified from the raw metadata. In examples, the data structure may be provided as a table, where each compute node may be provided as an entry or line item that includes the unique identifier of the compute node and values for each attribute.

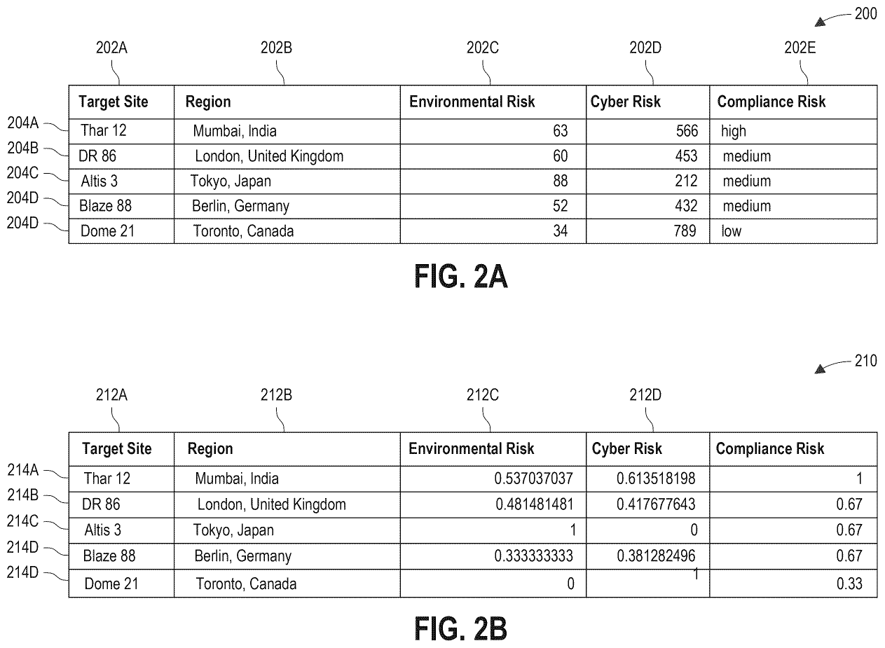

FIG. 2A illustrates an example data structure 200 of an excerpt of raw metadata descriptive of compute nodes at identified target sites. The raw metadata may be obtained by data processing engine 110 from third party systems 130 and can be stored as a data structure 200. The data structure 200, in this example, is provided as a table having columns 202A-202E that specify attributes of compute nodes and rows 204A-204E that specify values for each attribute in columns 202A-202E. For example, row 204A (also referred to as an entry or line item) represents compute node having a first attribute “Target site” with a value of “Thar 12”, a second attribute “Region” with a value of “Mumbai, India”, a third attribute “Environmental Risk” having a value of 63, and so on.

FIG. 2B illustrates an example processed feature list 210 generated by data processing engine 110 after executing one or more processing operations described above. The processed feature list 210, in this example, is provided as a table having columns 212A-212E that specify attributes of compute nodes and rows 214A-214E that specify processed values for each attribute in columns 212A-212E. For example, column 212C contains values that have been normalized and factor scaled to lie between a range of 0 and 1, with the highest value from column 202C of data structure 200 being equated to 1. Column 212D contains values that have been similarly processed. Likewise, the qualitative data in column 202E of data structure 200 have been converted (e.g., encoded) to quantitative (e.g., numerical) values, where “high” is equated to 1 and “low” is equated to 0, in this example.

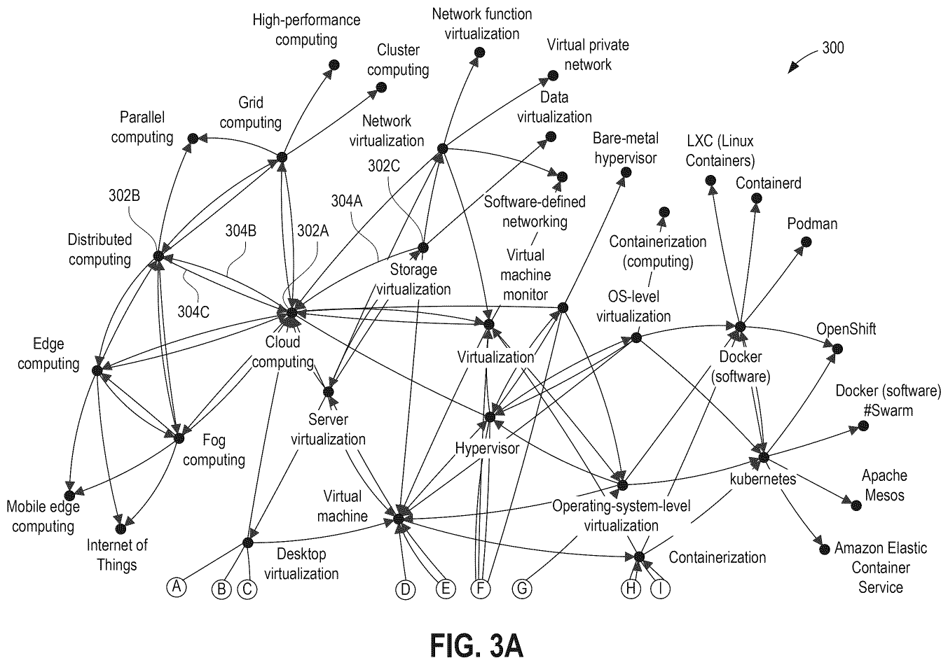

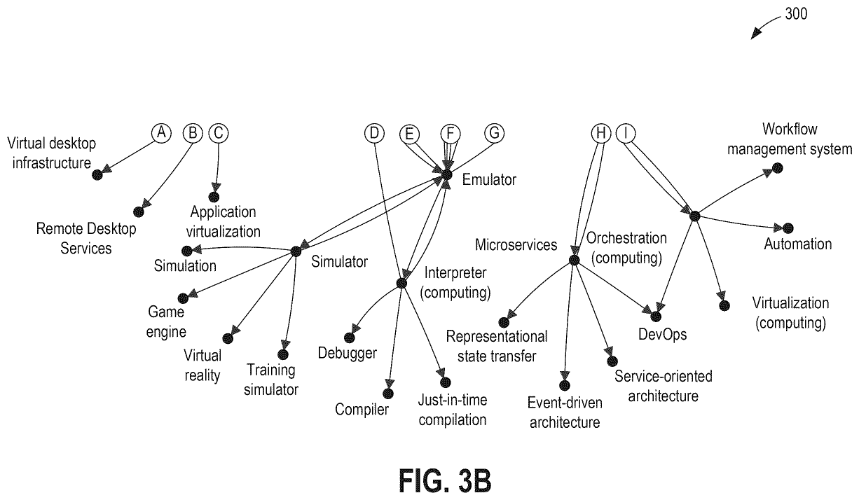

Domain knowledge integration engine 112 is configured to generate a domain-specific knowledge graph from the domain-specific data. In examples, domain knowledge integration engine 112 may apply an ML model 117 to the domain-specific data that is specific to the domain of the compute nodes and/or computation resources. The ML model 117 may ingest the domain-specific data and generate a domain-specific knowledge graph for the particular domain of compute nodes (e.g., a compute node knowledge graph in this example). Example compute node knowledge graphs are shown in FIGS. 3A-4. FIGS. 3A and 3B depict a larger, more complex domain-specific knowledge graph 300 generated by applying the ML model 117 to a Wikipedia page on Virtual Machines (e.g., https://en.wikipedia.org/wiki/Virtual_machine), while FIG. 4 depicts a simplified domain-specific knowledge graph 400.

In the example of FIGS. 3A and 3B, the domain-specific knowledge graph contains a plurality of nodes (example nodes are identified as nodes 302A-302C) and a plurality of connectors (example connectors are identified as connectors 304A-304C) that interconnect the plurality of nodes. The domain knowledge integration engine 112 may utilize the ML model to discover a plurality of domain-specific features and a plurality of domain-specific relationships between the plurality of domain-specific features from the domain-specific data, and convert the plurality of domain-specific features to the plurality of nodes. Domain knowledge integration engine 112 may also construct the plurality of connectors between the plurality of nodes according to the domain-specific relationships discovered by the ML model 117. For example, referring to the example node 302, ML model 117 may identify cloud computing, storage virtualization, distributed computing, etc. as domain-specific features of compute nodes from domain-specific data stored in domain-specific data store 115. The domain knowledge integration engine 112 may generate nodes 302A-302C to represent these domain-specific features. The ML model 117 can be executed to identify domain-specific relationships between the domain-specific features, as well as strengths of the domain-specific relationship, from semantics in the domain-specific data. The domain knowledge integration engine 112 may use these domain-specific relationships to construct connectors 304A-304C between the nodes 202A-202C, which weights can be assigned to each connector 202A-202C according to the strength of the domain-specific relationship.

In various examples, domain knowledge integration engine 112 may obtain domain-specific data from the domain-specific data sources 140. The domain-specific data may be provided in any format, such as JSON. XML, or binary, as well as natural human readable language, audio data, image/video data, or any data type. In some examples, the data is ingested by collecting, receiving, and storing the domain-specific data in domain-specific data store 115. In some examples, domain knowledge integration engine 112 may obtain the domain-specific data directly from domain-specific data sources 140 by querying an API, as well as indirectly from domain-specific data sources 140, for example, by mining.

In examples implementations, domain knowledge integration engine 112 may be configured to execute one or more LLM tools (e.g., the GPT series of models, Gemini, LLAMA models, and the like) as the ML model. LLM tools may be trained to understand semantics of domain-specific data obtained by domain knowledge integration engine 112. The domain knowledge integration engine 112 can utilize LLM tools can be configured to understand semantic of domain-specific data obtained by domain knowledge integration engine 112 by parsing the domain-specific data. The domain knowledge integration engine 112 can execute the LLM tools on the domain-specific data to identify domain-specific features therein and domain-specific relationships between these domain-specific features. The domain knowledge integration engine 112 can then utilize this knowledge to create a weighted domain-specific knowledge graph that captures the relations between the domain-specific features expressed in the domain-specific data, as well as the strength of the domain-specific relationships. As alluded to above, domain-specific features can be provided as nodes and connectors, which represent the strength of domain-specific relationships between nodes, can provide weightages of the interdependence between connected nodes.

Referring to FIG. 4 as an example, the example domain-specific graph 400 can be created using an ML model 117 that leverages one or more LLMs. In this example, the ML model 117 is applied to a short content document that states “The backups of compute nodes get stored at a target site. The risk score of a target site depends on environmental risk, cyber risk and compliance risk out of which environmental risk plays a comparatively higher role.” The ML model 117 parses this content to discover the following semantics: (Virtual Machines) --[have]--> (Backups); (Backups) --[stored at]--> (Target Site); (Target Site) --[has]--> (Risk Score); (Risk Score) --[depends on]--> (Environmental Risk); (Risk Score) --[depends on]--> (Cyber Risk); and (Risk Score) --[depends on]--> (Compliance Risk). Domain knowledge integration engine 112 can construct the domain-specific knowledge graph 400 from these semantics by identifying domain-specific features 402A-402F and generating a plurality of nodes 404A-404F. Each node 404A-404D is assigned (e.g., associated with) a domain-specific feature 402A-402F. domain knowledge integration engine 112 then identifies a plurality of domain-specific relationships 406A-406D and constructs a plurality of connectors 408A-408D using the domain-specific relationships 406A-406D. Each connector 408A-408D is assigned (e.g., associated with) a domain-specific relationship 406A-406D.

Domain knowledge integration engine 112 can leverage ML model 117 to discover strengths of each domain-specific relationship 406A-406D. For example, the statement “The risk score of a target site depends on environmental risk, cyber risk and compliance risk out of which environmental risk plays a comparatively higher role,” can be parsed to infer that domain-specific feature 402B (“Risk score”) depends more on domain-specific feature 404D (“Environmental risk”) than domain-specific features 404A (“Cyber risk”) or 404C (“Compliance risk”), and that domain-specific feature 402B does not depend on domain-specific features 402F or 402E. ML model 117 can thus infer that domain-specific relationship 408C should be comparatively stronger than domain-specific relationships 406A or 406B and assign a weight to each corresponding connector 408A-408C. In this example, ML model 117 may infer weightages of 0.5 for connector 408C and 0.25 for connectors 408A and 408D. The total weight may sum to 1. The resulting domain-specific knowledge graph may be referred to as a weighted domain-specific knowledge graph.

While FIG. 4 illustrates a simplified example for illustrative purposes, in practice, domain-specific knowledge graphs can become vast and intricate, involving thousands of interconnected entities. However, the same or similar parsing processing and assigning for nodes, connectors, and weights can be performed as easily in extensive knowledge graph(s) as the simplified version shown herein.

Feature extraction engine 114 may be configured to extract a subset of domain-specific features associated with an input tag from a plurality of domain-specific features. In examples, the input tag may be supplied by client device 120, for example, by entering a target tag into an input device 122 of the client device 120. Client device 120 may be any computing device or system, such as, but not limited to, a smartphone, a laptop computer, a personal computer, a tablet, a wearable smart device, etc. The input device 122 may be for example, but not limited to, alphanumeric and other keys; a mouse, a trackball, or cursor direction keys for communicating direction information and command selections; touches and on a touch screen; and voice command inputs.

A user may input a target tag into the client device 120, which can be transmitted to the feature extraction engine 114, for example, as a query through an API interface. The feature extraction engine 114 may locate a node (referred to as an input node) from the plurality of nodes in the domain-specific knowledge graph corresponding to the input tag received from the client device 120. The feature extraction engine 114 may be configured to identify a subset of nodes connected to the input node and extract the subset of domain-specific features corresponding to the identified nodes. Feature extraction engine 114 may also extract the weights of the domain-specific relationships between the extracted domain-specific features based on the connectors used to identify the connected nodes (e.g., extract the weights of the connectors used to identify the connected nodes). In examples, feature extraction engine 114 may provide the extracted subset of domain-specific features and weights as a structured list of extracted domain-specific features and associated weights.

Continuing the example of FIG. 4, feature extraction engine 114 may receive a query containing an input tag of “Risk score.” Feature extraction engine 114 may be configured to query the weight domain-specific knowledge graph 400 using the input tag “Risk score.” Feature extraction engine 114 locates the node 404B corresponding to the input tag and identifies nodes 404A, 404C and 404D connected to the node 404B via connectors 408A-408C. Feature extraction engine 114 can extract the domain-specific features 402D, 402A, and 402C and weights associated with connectors 408A-408C. The weights can be assigned to each domain-specific feature based on the connectors 408A-408C. Feature extraction engine 114 may create a data structure that contains the extracted domain-specific features and weights. The data structure may be stored as {‘Cyber risk’; weight: 0.25, ‘Environmental risk’; weight: 0.5, ‘Compliance risk’; weight: 0.25}. In another example, the data structure may be provided as a table.

Metadata tag score engine 116 is configured to determine metadata tag scores for compute node of the third party systems 130 based on the extracted domain-specific features and assigned weights. For example, metadata tag score engine 116 can be configured to generate a metadata score algorithm from the subset of domain-specific features and weights extracted by feature extraction engine 114. Metadata tag score engine 116 can execute the metadata score algorithm to compute a metadata tag score for each compute node. In various examples, each extracted domain-specific feature may represent a variable parameter in the metadata score algorithm weighted according to the extracted weights. In examples, the metadata score algorithm may be provided as a summation of the variable parameters and corresponding weights. An example metadata score algorithm that is based on the domain-specific knowledge graph 400 and input tag “Risk score” is provided below:

$$risk\_score = \text{} 0.5 ( environmental\_risk ) + 0.25 ( cyber\_risk ) + 0.25 ( compliance\_risk ) \qquad Eq . 1$$

To compute a metadata tag score, a value for each variable parameter (e.g., extracted domain-specific feature) can be obtained from the processed feature list generated by the data processing engine 110. Metadata tag score engine 116 may populate the variable parameters with values obtained from the processed feature list. For example, for each entry in the processed feature list, the metadata tag score engine 116 may locate a value from the processed feature list for an attribute corresponding to an extracted domain-specific feature. For example, referring to processed feature list 210, a metadata score tag for “Risk score” can be computed for row 214A by populating variable “environmental_risk” in Eq. 1 with “0.537037037” from column 212C; variable “cyber_risk” in Eq. 1 with “0.613518198” from column 212D; and variable “compliance_risk” in Eq. 1 with “1” from column 212D. In this way, values for each extracted domain-specific feature can be located and used to populate the metadata score algorithm. The metadata score algorithm can be executed for each compute node, specified in the metadata, to obtain metadata tag scores.

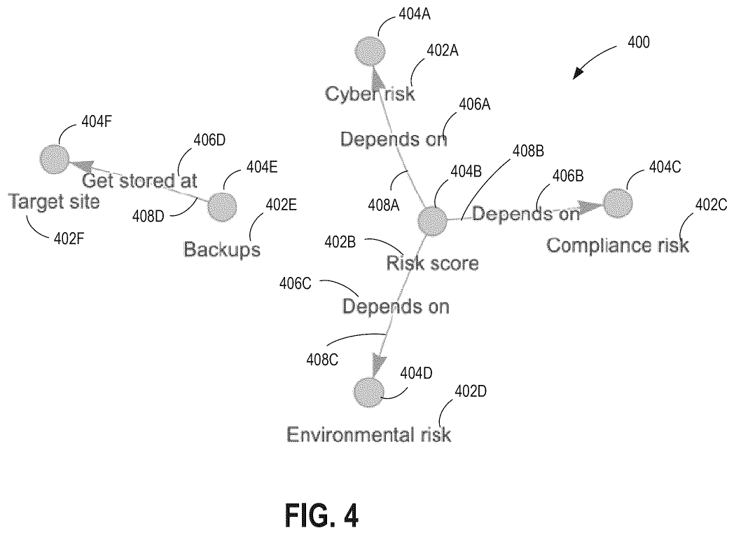

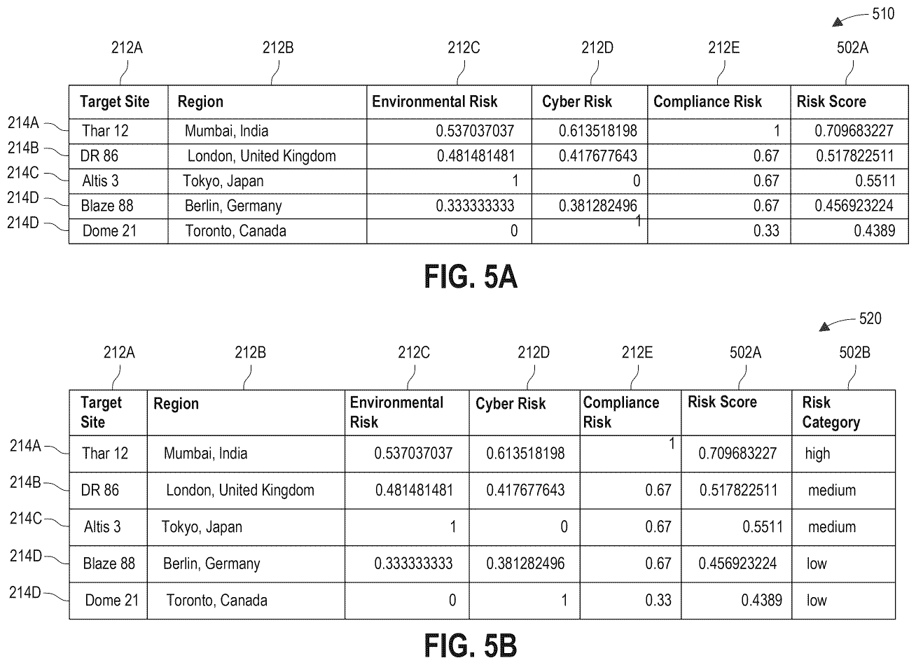

Once metadata tag scores are determined, clustering engine 118 may be configured to tag each compute node with a respective metadata tag score. For example, FIG. 5A depicts an example data structure 510 in which metadata descriptive of compute nodes of third party systems 130 is updated with respective metadata tag scores (e.g., the compute nodes of third party systems 130 are tagged with the metadata tag scores). Data structure 510 includes the columns 212A-212E and rows 214A-214B of FIG. 2A, and adds column 502A to include, in each row, an entry for a “Risk score” determined for each compute node in accordance with the above example.

Clustering engine 118 can be configured to cluster the compute nodes according to the metadata tag scores. For example, clustering engine 118, once the metadata tag scores are determined and assigned (e.g., tagged) to respective compute nodes, clustering engine 118 may execute a clustering algorithm, such as but not limited to, a k-means algorithm, hierarchical clustering algorithm, and density-based clustering algorithm, to name a few examples. The choice of clustering algorithm can depend on the nature of the data, the number of clusters desired, and the specific requirements of a particular use case. Regardless of the algorithm selected, clustering engine 118 may be configured to groups compute nodes of similar metadata tag scores. In an illustrative example, compute nodes having metadata tag scores within a designated range may be grouped together, for examples, the top 33% scores may be grouped as a first cluster, the middle 33% may be grouped as a second cluster, and the bottom 33% may be grouped as a third cluster. Other threshold ranges may be implemented depend on the nature of the data, the number of clusters desired, and the specific requirements of a particular use case. In some examples, clustering engine 118 may be configured to groups compute nodes of similar metadata tag scores profiles into distinct clusters. For example, metadata tag score engine 116 may be compute a metadata tag scores for a plurality of input tags, such as “Cost”, “Performance”, and “Risk.” In this case, one cluster might contain resources with relatively high “Cost” scores and relatively low “Performance” scores (e.g., within designated thresholds defining high and low groups), while another cluster might contain resources with relatively low “Risk score” value.

FIG. 5B illustrates an example data structure 520 in which the entries of the data structure 510 are clustered according to “Risk Score.” In this example, clustering engine 118 classified each compute node into risk categories (column 502B) according to “Risk Score” (e.g., high, medium, or low risk) and reordered the entries according to risk categories.

While the examples shown in FIGS. 5A and 5B depict the data structure of the processed feature list 210 as including columns 502A and/or 502B, in another example, clustering engine 118 may be configured to tag the compute nodes by updating the data structure 200 of raw metadata. For example, column 502A may be added to data structure 200 and clustering engine 118 may cluster the nodes and update data structure 200 to include column 502B, in a manner similar to that described above in connection with the processed feature list 210.

Based on the clusters determined by clustering engine 118, data tagging system 102 may be configured to determine a configuration of the compute nodes that optimizes third party systems 130 according to the metadata tag scores. For example, data tagging system 102 may be configure the third party systems 130 to favor a cluster of compute nodes having low Cost scores and high Performance scores over a cluster of compute nodes having low Risk scores and low Cost scores. As an illustrative example, real time traffic data may be stored and/or backed up in compute nodes having a higher Performance score opposed to compute nodes having a low Risk score.

While certain examples above are described with respect to a “Risk score,” the present disclosure is not intended to be limited to the illustrative examples. Scores for other tags may be similarly determined. For example, table 1 below lists additional examples tags (e.g., input tags that can be used to query data tagging system 102) and domain-specific features on which the tags may depend. The below are provided as non-limiting examples, and it will be understood that implementations disclosed herein may be applicable to various different tags according to a desired application.

TABLE 1

| Tag | Associated features |
|---|---|
| cost | cost_per_gb, site_operational_cost, . . . |
| performance | IOPS, Throughput, Latency, Number of CPU cores, |
| | Clock speed of the CPUs |
| risk(for a site) | environmental_risk(flood, earthquake), cyber_risk, |
| | compliance_risk . . . |

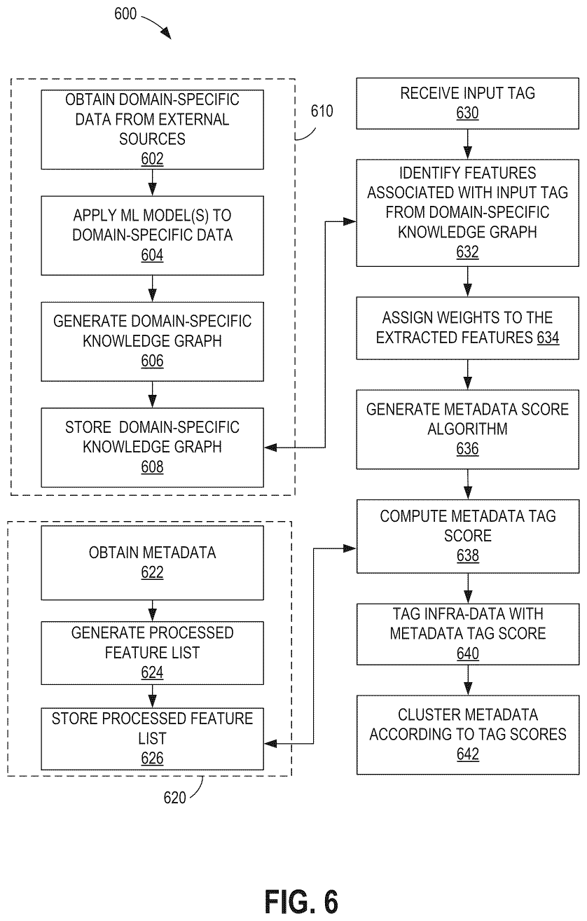

FIG. 6 illustrates an example process 600 for performing automated metadata tag score determination, in accordance with examples disclosed herein. One or more of the operations that make up process 600 may be executed by the data tagging system 102 as machine-readable instructions to perform the operations described herein.

During a domain data integration phase 610, domain-specific data may be obtained from domain-specific data sources (operation 602). For examples, domain-specific data may be obtained from domain-specific data sources 140 of FIG. 1 by directly querying an API of the domain-specific data sources 140. Domain-specific data can also be obtained indirectly from domain-specific data sources 140, for example, by mining through log files, audit files, etc. As described above, the domain-specific data may be specific to a particular domain of interest.

At operation 604, one or more ML models are applied to the domain-specific data obtained at operation 602. For example, one or more ML models (e.g., ML model 117) can be applied to the domain-specific data to parse through the content and discover domain-specific semantics contained therein. The ML model may discover domain-specific features and interdependencies therebetween (e.g., domain-specific relationships) from the domain-specific semantics, as well as strengths of reliance in those interdependencies. The ML model may infer a weight for each domain-specific relationship, as described above in connection with FIG. 1.

At operation 606, a domain-specific knowledge graph can be generated, for example, from the domain-specific features and domain-specific relationships discovered during operation 604. For example, operation 606 may generate a plurality of nodes, one for each domain-specific feature, and a plurality of connectors, one for each domain-specific relationship. The domain-specific knowledge graph can be constructed by connecting the plurality of nodes using the plurality of connectors according to the discovered domain-specific relationships. The plurality of domain-specific features can be assigned to the nodes and the plurality of domain-specific relationships assigned to the connectors. Operation 606 may also include assign weights to each connector according to the weights inferred for corresponding domain-specific relationships, as described above in connection with FIGS. 1-5.

The domain-specific knowledge graph can then be stored at operation 608 for subsequent access and retrieval.

During a data preprocessing phase 620, raw metadata can be obtained from data sources (operation 622). For example, operation 622 may obtain raw metadata descriptive of instance of the domain (e.g., compute nodes and/or computation resources as described above in connection with FIGS. 1-5) from third party systems 130. In examples, operation 622 may include querying an API of third party systems 130 to obtain raw metadata directly, as well as indirectly, for example, by mining through log files, audit files, or the like. FIG. 2A illustrates an example excerpt of raw metadata that can be obtained during operation 622.

At operation 624, a processed feature list is generated. For example, operation 624 may process the raw metadata to facilitate effective data processing. In examples, operation 624 may include one or more of: cleaning the raw metadata, normalizing the raw metadata, feature scaling, and manage missing values. The processed metadata can be organized into a data structure. For example, FIG. 2B illustrates an example processed feature list obtained by executing operation 624 on the raw metadata of FIG. 2A.

The processed feature list can then be stored at operation 626 for subsequent access and retrieval.

At operation 630, an input tag may be received, for example, from a user device (e.g., client device 120). In examples, a user device may transmit a query that includes a tag of interest. The tag included in the query can be used an input tag to query the domain-specific knowledge graph generated during the domain data integration phase 610.

At operation 632, a subset of domain-specific features associated with the input tag can be extracted from the domain-specific knowledge graph. For example, the domain-specific knowledge graph can be queried using the input tag to locate a node (referred to as an input node) of the domain-specific knowledge graph corresponding to the input tag. A subset of nodes connected to the input node can be identified based on connectors of the domain-specific knowledge graph. Once the connected nodes are identified, operation 632 may extract the domain-specific features associated with the identified nodes.

At operation 634, weights can be assigned (e.g., associated with) the extracted domain-specific features. For example, as described above, weights associated with the connectors can be extracted from the domain-specific knowledge graph and associated with the nodes identified during operation 632. A data structure can then be constructed at operation 634 that comprises the extracted domain-specific features and associated weights, as described above in connection with FIG. 1.

At operation 636, a metadata score algorithm can be generated, for example, based on the data structure constructed at operation 634. For example, as described above in connection with FIG. 1, each extracted domain-specific feature may represent a variable parameter in the metadata score algorithm that can be weighted according to the extracted weights. In examples, the metadata score algorithm may be provided as a summation of the variable parameters multiplied by the corresponding weights.

At operation 638, one or more metadata tag scores can be computed. For example, values for each variable parameter (e.g., extracted domain-specific feature) can be obtained from the processed feature list stored at operation 626. The obtained values can be inserted into the metadata score algorithm as the variable parameters with. As an example, for each entry (e.g., line item or instance) contained in the processed feature list, a value for an attribute corresponding to an extracted domain-specific feature can be obtained from the processed feature list, and this value used to construct a metadata score algorithm specific for a respective entry. A metadata score algorithm can be constructed for each entry specified in the metadata, and used to obtain metadata tag scores for each entry.

At operation 640, each entry from the metadata can be tagged with a respective metadata tag score. For example, as shown in FIG. 5A, each entry of the processed feature list can be updated to include a respective metadata tag score. In another example, each entry of the raw metadata can be updated to include a respective metadata tag score.

At operation 642, the entries of the metadata can be clustered according to the metadata tag scores. For example, operation 642 may include executing a clustering algorithm on the processed feature list (or raw metadata) resulting tagged with the metadata scores (e.g., operation 640) that groups the entries into clusters of similar metadata scores. Example clustering algorithms include, but are not limited to, a k-means algorithm, hierarchical clustering algorithm, and density-based clustering algorithm, to name a few examples. The choice of clustering algorithm can depend on the nature of the data, the number of clusters desired, and the specific requirements of a particular use case. Similarity of the metadata tag scores may be determined according to the selected clustering algorithm as well as the distribution of the metadata tag scores. As an example, certain threshold ranges of metadata tag scores may be used to delineate between groups of entries. The thresholds may be set according to percentiles (e.g., a top percentile, one or more middle percentiles, a bottom percentile), numbers of entries (e.g., top n-number of metadata tag scores, one or more middle n-number of scores, bottom n-number of scores), and so on.

As described above, in some example, once the entries of the metadata are clustered, actions may be taken based on the clusters. Various actions may be taken according to the objects described by the metadata. In the above examples, a configuration of compute nodes can be optimized according to the clustered. As another example, more backup policies can be added to a compute node that is having a High Performance and high Criticality score (as another example metadata tag that can be scored in accordance with the examples disclosed herein).

In another example, the disclosed technology may be applied to medical field for curing diseases. In this case, a domain-specific knowledge graph can be generated for medical diseases and metadata tags, such as risk to the general population, scored. In this case, increased funds can be allocated to diseases having high risk score over diseases that are medium or low risk. In another example, personal loan rates can be personalized based on financial health score categories (e.g., good, average, low). These are just some examples of the numerous applications of the disclosed technology and are not intended to limit the scope of the present disclosure.

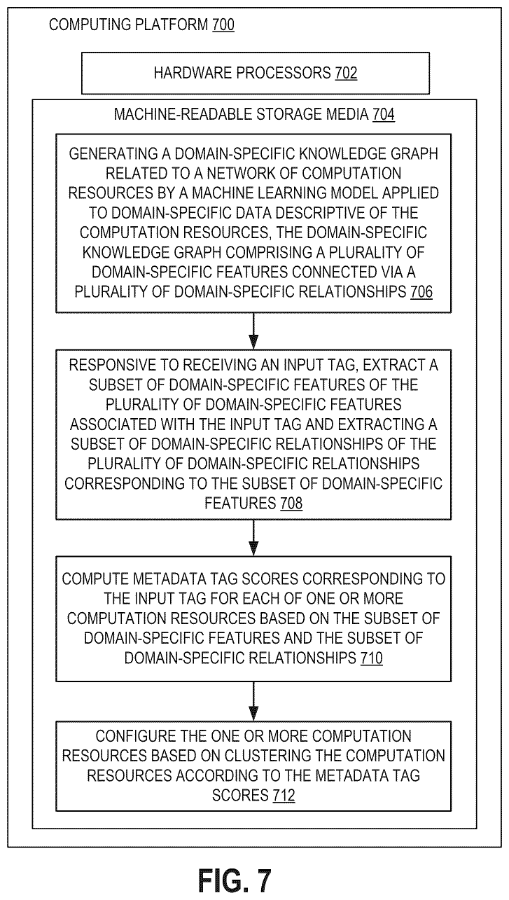

FIG. 7 illustrates a computing component that may be used to implement automated metadata tag determinations in accordance with various examples of the disclosed technology. Referring now to FIG. 7, computing component 700 may be, for example, a server computer, a controller, or any other similar computing component capable of processing data. In the example implementation of FIG. 7, the computing component 700 includes a hardware processor 702, and machine-readable storage medium 704.

Hardware processor 702 may be one or more central processing units (CPUs), semiconductor-based microprocessors, and/or other hardware devices suitable for retrieval and execution of instructions stored in machine-readable storage medium 704. Hardware processor 702 may fetch, decode, and execute instructions, such as instructions 706-712, to control processes or operations for performing automated metadata tag determinations. As an alternative or in addition to retrieving and executing instructions, hardware processor 702 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 714, may be any electronic, magnetic, optical, or other physical storage device that contains or stores executable instructions. Thus, machine-readable storage medium 704 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 704 may be a non-transitory storage medium, where the term “non-transitory” does not encompass transitory propagating signals. As described in detail below, machine-readable storage medium 704 may be encoded with executable instructions, for example, instructions 706-712.

Hardware processor 702 may execute instruction 706 to generate a domain-specific knowledge graph related to a network of computation resources by a ML model applied to domain-specific data descriptive of the computation resources. In examples, the domain-specific knowledge graph comprises a plurality of domain-specific features, represented as a plurality of nodes, connected via a plurality of domain-specific relationships, represented as a plurality of connectors. FIGS. 3A-4 illustrate example domain-specific knowledge graphs. Instructions 706 cause the hardware processor 702 to generate the domain-specific knowledge graph, for example, as described above in connection with FIGS. 1-6.

Hardware processor 702 may execute instruction 708 to, responsive to receiving an input tag, extract a subset of domain-specific features of the plurality of domain-specific features associated with the input tag. Instruction 708 may also cause the hardware processor 702 to extract a subset of domain-specific relationships of the plurality of domain-specific relationships corresponding to the subset of domain-specific features. For example, the hardware processor 702 may extract the subset of domain-specific features and domain-specific relationships as described above in connection with FIGS. 1-6.

Hardware processor 702 may execute instruction 710 to compute metadata tag scores corresponding to the input tag for each of one or more computation resources based on the subset of domain-specific features and the subset of domain-specific relationships. For example, as described above in connection with FIGS. 1-6, instruction 710 may cause hardware processor 702 to generate a metadata score algorithm and populate the metadata score algorithm using metadata descriptive of the compute nodes. Weights for the metadata score algorithm may be obtained based on the plurality of domain-specific relationships, as described above in connection with FIGS. 1-6.

Hardware processor 702 may execute instruction 710 to configure the one or more computation resources based on clustering the computation resources according to the metadata tag scores. For example, as described above in connection with FIGS. 1-6, instruction 710 may cause the hardware processor 702 to update metadata descriptive of the computation resources with the metadata tag scores and cluster entries of the metadata using to the metadata tag scores according to a clustering algorithm. Based on the clustering, the network of computation resources can be optimized for a give task or workload.

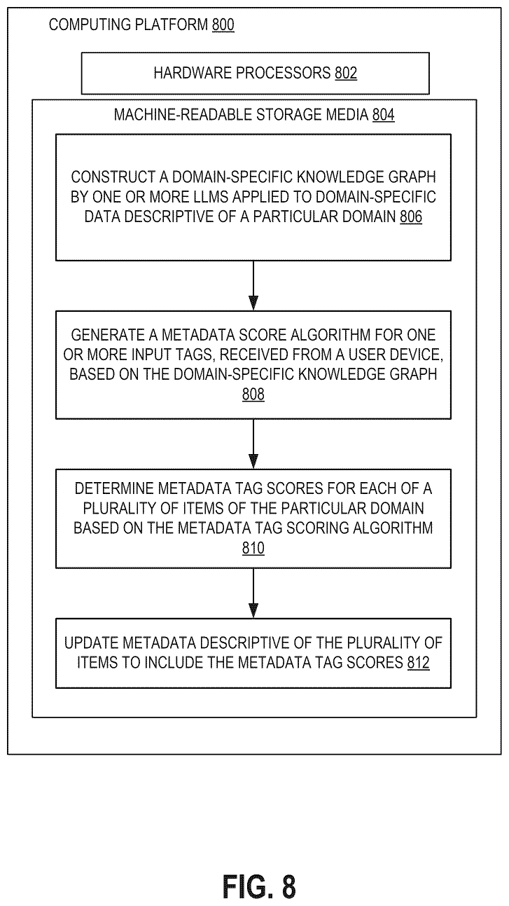

FIG. 8 illustrates another computing component that may be used to implement automated determining of metadata tags in accordance with various examples of the disclosed technology. Referring now to FIG. 8, computing component 800 may be, for example, a server computer, a controller, or any other similar computing component capable of processing data. In the example implementation of FIG. 8, the computing component 800 includes a hardware processor 802, and machine-readable storage medium 804.

Hardware processor 802 may be one or more central processing units (CPUs), semiconductor-based microprocessors, and/or other hardware devices suitable for retrieval and execution of instructions stored in machine-readable storage medium 804. Hardware processor 802 may fetch, decode, and execute instructions, such as instructions 806-812, to control processes or operations for performing automated metadata tag determinations. As an alternative or in addition to retrieving and executing instructions, hardware processor 802 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 314, may be any electronic, magnetic, optical, or other physical storage device that contains or stores executable instructions. Thus, machine-readable storage medium 804 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 804 may be a non-transitory storage medium, where the term “non-transitory” does not encompass transitory propagating signals. As described in detail below, machine-readable storage medium 804 may be encoded with executable instructions, for example, instructions 806-812.

Hardware processor 802 may execute instruction 806 to construct a domain-specific knowledge graph by one or more LLMs applied to domain-specific data descriptive of a particular domain. Examples of constructing or otherwise generating a domain-specific knowledge graph are provided above in connection with FIGS. 1-6.

Hardware processor 802 may execute instruction 808 to generate a metadata score algorithm for one or more input tags, received from a user device, based on the domain-specific knowledge graph. Generating a metadata score algorithm can be performed in accordance with the examples described above in connection with FIGS. 1-6.

Hardware processor 802 may execute instruction 810 to determine metadata tag scores for each of a plurality of items of the particular domain based on the metadata score algorithm. For examples, the metadata score algorithm can be populated with weights obtained from the domain-specific knowledge graph and values obtained from metadata descriptive of items or instances of the particular domain. A metadata tag score can then be computed for each items from the metadata score algorithm, for examples, as described in connection with FIGS. 1-6.

Hardware processor 802 may execute instruction 810 to update metadata descriptive of the plurality of items to include the metadata tag scores. For example, the metadata tag scores can be added to the metadata, which tags the items with the metadata tag scores, as described above in connection with FIGS. 1-6.

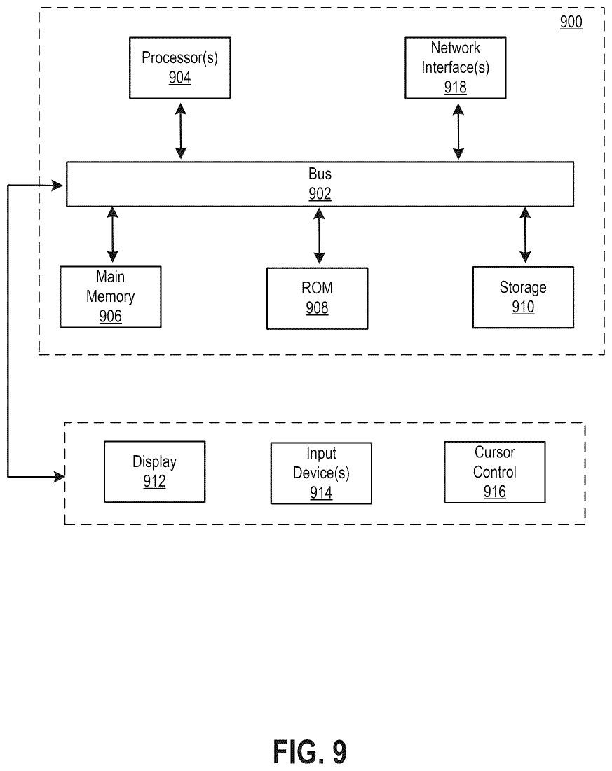

FIG. 9 depicts a block diagram of an example computer system 900 in which various examples of the disclosed technology described herein may be implemented. The computer system 900 includes a bus 902 or other communication mechanism for communicating information, one or more hardware processors 904 coupled with bus 902 for processing information. Hardware processor(s) 904 may be, for example, one or more general purpose microprocessors. The computer system 900 may be implemented as one or more component of the environment 100 described in connection with FIGS. 1-5B, for example, computer system 900 may be implemented as one or more of data tagging system 102, client device 120, third party systems 130, and/or domain-specific data sources 140.

The computer system 900 also includes a main memory 906, such as a random access memory (RAM), cache and/or other dynamic storage devices, coupled to bus 902 for storing information and instructions to be executed by processor 904. Main memory 906 also may be used for storing temporary variables or other intermediate information during execution of instructions to be executed by processor 904. Such instructions, when stored in storage media accessible to processor 904, render computer system 900 into a special-purpose machine that is customized to perform the operations specified in the instructions. For example, main memory 906 may store instructions, that when executed by processor(s) 904, cause computer system 900 to perform one or more of the operations described in connection with FIGS. 1-6.

The computer system 900 further includes a read only memory (ROM) 908 or other static storage device coupled to bus 902 for storing static information and instructions for processor 904. A storage device 910, such as a magnetic disk, optical disk, or USB thumb drive (Flash drive), etc., is provided and coupled to bus 902 for storing information and instructions.

The computer system 900 may be coupled via bus 902 to a display 912, such as a liquid crystal display (LCD) (or touch screen), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. In some examples, the same direction information and command selections as cursor control may be implemented via receiving touches on a touch screen without a cursor.

The computing system 900 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 900 may implement the techniques described herein using customized hard-wired logic, one or more ASICs or FPGAs, firmware and/or program logic which in combination with the computer system causes or programs computer system 900 to be a special-purpose machine. According to one example of the disclosed technology, the techniques herein are performed by computer system 900 in response to processor(s) 904 executing one or more sequences of one or more instructions contained in main memory 906. Such instructions may be read into main memory 906 from another storage medium, such as storage device 910. Execution of the sequences of instructions contained in main memory 906 causes processor(s) 904 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 910. Volatile media includes dynamic memory, such as main memory 906. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 902. Transmission media can also take the form of acoustic or light waves, such as those generated during radio-wave and infra-red data communications.

The computer system 900 also includes a network interface 918 (also referred to as a communication interface) coupled to bus 902. Network interface 918 provides a two-way data communication coupling to one or more network links that are connected to one or more local networks. For example, network interface 918 may be an integrated services digital network (ISDN) card, cable modem, satellite modem, or a modem to provide a data communication connection to a corresponding type of telephone line. As another example, network interface 918 may be a local area network (LAN) card to provide a data communication connection to a compatible LAN (or WAN component to communicated with a WAN). Wireless links may also be implemented. In any such implementation, network interface 918 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through network interface 918, which carry the digital data to and from computer system 900, are example forms of transmission media.

The computer system 900 can send messages and receive data, including program code, through the network(s), network link and network interface 918. In the Internet example, a server might transmit a requested code for an application program through the Internet, the ISP, the local network and the network interface 918.

The received code may be executed by processor 904 as it is received, and/or stored in storage device 910, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 900.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
generating a domain-specific knowledge graph related to a network of computation resources by a machine learning model applied to domain-specific data descriptive of the computation resources, the domain-specific knowledge graph comprising a plurality of domain-specific features connected via a plurality of domain-specific relationships;
responsive to receiving an input tag, extracting a subset of domain-specific features of the plurality of domain-specific features associated with the input tag and extracting a subset of domain-specific relationships of the plurality of domain-specific relationships corresponding to the subset of domain-specific features;
computing metadata tag scores corresponding to the input tag for each of one or more computation resources based on the subset of domain-specific features and the subset of domain-specific relationships; and
configuring the one or more computation resources based on clustering the computation resources according to the metadata tag scores.

2. The method of claim 1, wherein the machine learning model comprises a Large Language Model (LLM).

3. The method of claim 1, wherein each of the subset of domain-specific relationships defines a weight, wherein the metadata tag scores are computed based on the weights.

4. The method of claim 1, wherein the computation resources comprise one or more virtual machines.

5. The method of claim 1, further comprising:
inputting data descriptive of the computation resources into the machine learning model as the domain-specific data.

6. The method of claim 1, wherein the domain-specific knowledge graph comprises a plurality of nodes representing the plurality of domain-specific features and a plurality of connections between the plurality of nodes representing the plurality of domain-specific relationships.

7. The method of claim 6, wherein the input tag corresponds to an input node of the domain-specific knowledge graph and the subset of domain-specific features corresponds to a subset of nodes of the domain-specific knowledge graph connected to the node.

8. The method of claim 7, wherein extracting the subset of domain-specific features and the subset of domain-specific relationships comprises:
locating the input node, on the domain-specific knowledge graph, corresponding to the input tag; and
identifying the subset of nodes of the plurality of nodes connected to the input node,
wherein the subset of domain-specific relationships correspond to connectors connecting the input node to each of the subset of nodes.

9. A system, comprising:
a memory storing instructions; and
at least one processor communicatively coupled to the memory and configured to execute the instructions to:
generate a domain-specific knowledge graph related to a network of computation resources by a machine learning model applied to domain-specific data descriptive of the computation resources, the domain-specific knowledge graph comprising a plurality of domain-specific features connected via a plurality of domain-specific relationships;
responsive to receiving an input tag, extract a subset of domain-specific features of the plurality of domain-specific features associated with the input tag and extracting a subset of domain-specific relationships of the plurality of domain-specific relationships corresponding to the subset of domain-specific features;
compute metadata tag scores corresponding to the input tag for each of one or more computation resources based on the subset of domain-specific features and the subset of domain-specific relationships; and
configure the one or more computation resources based on clustering the computation resources according to the metadata tag scores.

10. The system of claim 9, wherein the machine learning model comprises a Large Language Model (LLM).

11. The system of claim 9, wherein each of the subset of domain-specific relationships defines a weight, wherein the metadata tag scores are computed based on the weights.

12. The system of claim 9, wherein the computation resources comprise one or more virtual machines.

13. The system of claim 9, wherein the at least one processor is further configured to execute the instructions to:
input data descriptive of the computation resources into the machine learning model as the domain-specific data.

14. The system of claim 9, wherein the domain-specific knowledge graph comprises a plurality of nodes representing the plurality of domain-specific features and a plurality of connections between the plurality of nodes representing the plurality of domain-specific relationships.

15. The system of claim 14, wherein the input tag corresponds to an input node of the domain-specific knowledge graph and the subset of domain-specific features corresponds to a subset of nodes of the domain-specific knowledge graph connected to the node.

16. The system of claim 15, wherein extracting the subset of domain-specific features and the subset of domain-specific relationships comprises:
locating the input node, on the domain-specific knowledge graph, corresponding to the input tag; and
identifying the subset of nodes of the plurality of nodes connected to the input node,
wherein the subset of domain-specific relationships correspond to connectors connecting the input node to each of the subset of nodes.

17. A non-transitory computer-readable storage medium storing instructions that, when executed by a processor, cause the processor to:
construct a domain-specific knowledge graph by one or more Large Language Models (LLMs) applied to domain-specific data descriptive of a particular domain;
generate a metadata score algorithm for one or more input tags, received from a user device, based on the domain-specific knowledge graph;
determine metadata tag scores for each of a plurality of items of the particular domain based on the metadata score algorithm; and
update metadata descriptive of the plurality of items to include the metadata tag scores.

18. The non-transitory computer-readable storage medium of claim 17, wherein the domain-specific knowledge graph comprises a plurality of nodes connected via a plurality of connectors, wherein the plurality of nodes are based on a plurality of domain-specific features and the plurality of connectors are based on a plurality of domain-specific relationships between the plurality of nodes, wherein the plurality of domain-specific features and the plurality of domain-specific relationships are determined by the one or more LLMs from the domain-specific data.

19. The non-transitory computer-readable storage medium of claim 17, wherein the instructions, when executed by the processor, further cause the processor to:
for each item of the plurality of items, populate the metadata score algorithm with metadata descriptive of the item,
wherein the metadata tag scores are determined by executing the metadata score algorithm populated with the metadata descriptive of the item.

20. The non-transitory computer-readable storage medium of claim 18, wherein the instructions, when executed by the processor, further cause the processor to:
obtain weights for the metadata descriptive of the item from the domain-specific knowledge graph,
wherein the metadata tag scores are determined based on the weights.
